(19) United States
(12) Patent Application Publication
(10) Pub. No.: US 2023/0182168 A1
(43) Pub. Date: Jun. 15, 2023

(54) COATED STEEL SHEET AND HOME APPLIANCE USING THE SAME

(71) Applicants: Won Goo KANG, Seoul (KR); LG ELECTRONICS INC., Seoul (KR)

(72) Inventors: Kun Hyung PARK, Seoul (KR); Won Goo KANG, Seoul (KR); Hong Seung DO, Seoul (KR); Kuhyeong LEE, Seoul (KR); Rok Dam BAEK, Seoul (KR)

(21) Appl. No.: 18/078,445

(22) Filed: Dec. 9, 2022

(30) Foreign Application Priority Data
Dec. 13, 2021 (KR) 10-2021-0178051

(51) Int. Cl. B05D 5/06; B05D 7/14; B05D 3/12; B24B 7/22; B24B 7/19; B44F 7/00

(52) U.S. Cl. CPC B05D 5/061; B05D 7/148; B05D 3/12; B24B 7/22; B24B 7/19; B44F 7/00

(57) ABSTRACT

A coated steel sheet capable of implementing a rich three-dimensional effect, various patterns, and a natural esthetic sense and includes a steel sheet material which has a concave portion and a convex portion formed on one surface and a coating layer which is formed on the one surface by being coated on a coating material, wherein, as the coating layer is polished, at least a portion of the convex portion is exposed to an outside, and the concave portion is filled with the coating material.

### CROSS-REFERENCE TO RELATED APPLICATION(S)

This application claims priority to and the benefit of Korean Patent Application No. 10-2021-0178051, filed in Korea on Dec. 13, 2021, the disclosure of which is incorporated herein by reference in its entirety.

### BACKGROUND

1 Field

The present disclosure relates to a coated steel sheet and a home appliance using the coated steel sheet.

### 2. Background

In order to improve an ornamental effect with an excellent esthetic sense, patterns or irregular dull patterns are formed on surfaces of stainless steel sheets used as exterior materials of various home appliances. As methods of forming patterns on stainless steel sheets, an etching method in which patterns are formed by masking the patterns with acid-resistant paint and then etching a non-masked part and an embossing method in which embossed patterns are formed on a surface of a steel sheet by cold-rolling a hot-rolled coil using a rolling mill including an embossing roll are known.

Among the above methods, the conventional embossing method includes an operation in which patterns are formed by mounting a hot-rolled coil on a raw material molding device, welding and attaching a leader strip to both ends of a coil strip, mounting the coil strip on a rolling mill including an embossing roll, cold-rolling the coil strip to a required thickness, and then transferring patterns on the embossing roll to the coil strip, an operation in which the coil strip to be rolled is annealed and pickled, an operation in which the annealed coil strip is temper-rolled, an operation in which a surface of the coil strip is coated, and an operation in which the coil strip is cut and packaged.

The related art relating to such an embossed stainless steel sheet is disclosed in Korean Unexamined Patent Application Publication No. 10-1998-0000685. However, in the conventional embossing method, since an additional posttreatment process is not performed after a process of forming embossing on a steel sheet and a coating process of coating a surface of the steel sheet on which the embossing is formed, it is not possible to give a rich three-dimensional effect to the coated surface of the steel sheet, and it is difficult to implement various patterns and a natural esthetic sense.

### RELATED ART DOCUMENT

### Patent Document

(Patent Document 1) Korean Unexamined Patent Application Publication No. 10-1998-0000685.

### BRIEF DESCRIPTION OF THE DRAWINGS

Embodiments will be described in detail with reference to the following drawings in which like reference numerals refer to like elements, and wherein:

FIG. 1 (section A) is a cross-sectional view illustrating a steel sheet material having one surface on which a convex portion and a concave portion are formed, FIG. 1 (section B) is a cross-sectional view illustrating a coated steel sheet in which a coating layer is formed on the one surface on which the convex portion and the concave portion are formed, and FIG. 1 (section C) is a cross-sectional view illustrating a coated steel sheet according to an embodiment of the present disclosure;

FIG. 2 is a cross-sectional view illustrating a coated steel sheet according to another embodiment of the present disclosure;

FIG. 3 is a cross-sectional view illustrating a coated steel sheet according to still another embodiment of the present disclosure;

FIG. 4 is a flowchart schematically showing a method of manufacturing a coated steel sheet according to an embodiment of the present disclosure;

FIG. 5 is a process diagram schematically depicting the method of manufacturing a coated steel sheet according to an embodiment of the present disclosure;

FIG. 6 is a perspective view schematically depicting an operation of patterning and rolling a coated steel sheet according to an embodiment of the present disclosure;

FIG. 7 is a perspective view schematically depicting an operation of polishing the coated steel sheet according to an embodiment of the present disclosure;

FIG. 8 is a front view schematically depicting an operation of polishing a coated steel sheet according to another embodiment of the present disclosure;

FIG. 9 is a perspective view illustrating a coated steel sheet of the present disclosure that is processed to be used in a home appliance; and

FIG. 10 is a perspective view illustrating a home appliance (refrigerator) using the coated steel sheet.

### DETAILED DESCRIPTION

The objectives, features, and advantages will be described in detail below with reference to the accompanying drawings, and accordingly, those of ordinary skill in the art to which the present disclosure pertains should be able to easily practice the technical idea of the present disclosure. In describing the present disclosure, when it is determined that detailed description of a known art relating to the present disclosure may unnecessarily obscure the gist of the present disclosure, the detailed description thereof will be omitted. Hereinafter, exemplary embodiments according to the present disclosure will be described in detail with reference to the accompanying drawings. In the drawings, the same reference numerals are used to indicate the same or similar elements.

In this specification, a singular expression includes a plural expression unless the context clearly indicates otherwise. In this application, terms such as “comprise” or “include” should not necessarily be interpreted as indicating that all of various elements or various operations described in this specification are included and should be interpreted as indicating that some of the elements or some of the operations may not be included or additional elements or operations may be further included.

Hereinafter, a coated steel sheet, a home appliance using the same, and a method of manufacturing the coated steel sheet according to an embodiment of the present disclosure will be described in detail.

Coated Steel Sheet

A coated steel sheet according to the present disclosure may implement a rich three-dimensional effect, various patterns, and a natural esthetic sense that cannot be implemented using the conventional embossing method.

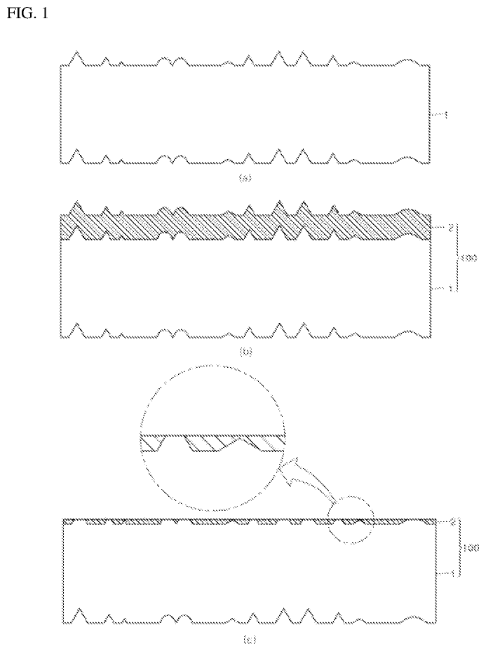

Referring to FIG. 1, a coated steel sheet 100 according to the present disclosure includes a steel sheet material 1 which has a concave portion and a convex portion formed on one surface and a coating layer 2 which is formed on the one surface by being coated on a coating material, and, as the coating layer 2 is polished, at least a portion of the convex portion is exposed to an outside, and the concave portion is filled with the coating material.

FIG. 1 (section A) illustrates a cross-sectional view of the steel sheet material 1 having the concave portion and the convex portion formed on the one surface thereof. The concave portion and the convex portion may be formed on both surfaces of the steel sheet material 1 or may be formed only on the one surface thereof. The concave portion and the convex portion may be formed on the steel sheet material 1 using a device such as an embossing roll or using other methods. For example, the steel sheet material 1 may be stainless steel but may be any other steel sheet material that can be used to form an exterior of a home appliance.

Next, FIG. 1 (section B) illustrates a cross-sectional view of a steel sheet in which the coating layer 2 is formed on the one surface of the steel sheet material 1, and FIG. 1 (section C) illustrates a coated steel sheet 100 according to the present disclosure. Referring to FIGS. 1B and 1C, in the coated steel sheet 100 according to the present disclosure, the coating layer 2 of the steel sheet illustrated in FIG. 1B is polished. Further, as illustrated in FIG. 1C, in the coated steel sheet 100 according to the present disclosure, at least a portion of the convex portion is exposed to the outside, and the concave portion is filled with the coating material. Accordingly, in the coated steel sheet 100 according to the present disclosure, a color difference between the steel sheet and the coating material may be prominent, and the texture may be different from that of the conventional coated steel sheet.

A known coating material may be used as the coating material constituting the coating layer 2. For example, acrylic or epoxy paint including a coloring agent may be used as the coating material. Further, a thickness of the coating layer 2 may be properly controlled corresponding to the sizes of the concave portion and the convex portion.

Preferably, referring to an enlarged view of FIG. 1 (section C), in the coated steel sheet 100 of the present disclosure, an upper surface of the convex portion that is exposed to the outside and an upper surface of a colored coating material with which the concave portion adjacent to the convex portion is filled may be collinear. Accordingly, a color of the steel sheet exposed due to the convex portion and a color of the coating layer exposed due to the coating material with which the concave portion is filled may naturally cross each other, and the coated steel sheet 100 of the present disclosure may have a rich three-dimensional effect and a natural esthetic sense.

Also, preferably, in the coated steel sheet 100 of the present disclosure, the coating layer 2 may have a nonuniform thickness due to a removal rate being different in some parts. In this way, due to the removal rate of the coating layer 2 being different in some parts thereof, the coated steel sheet 100 of the present disclosure can implement a natural gradation pattern effect.

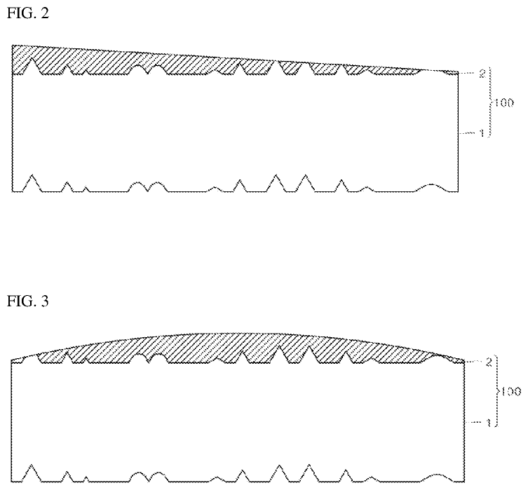

As a preferable example, referring to FIG. 2, in the coated steel sheet 100 according to one preferable embodiment of the present disclosure, a thickness of the coating layer may be the thickest at one side and the thinnest at the other side opposite to the one side in a longitudinal direction.

Further, referring to FIG. 3, in the coated steel sheet 100 according to another preferable embodiment of the present disclosure, the thickness may be the thickest at a central portion. In the present disclosure, the thickness of the coating layer 2 may be changed in various ways by selecting a polishing area of the coating layer 2, and accordingly, the present disclosure can implement various gradation pattern effects.

Home Appliance

The above-described coated steel sheet 100 may be applied to an outer portion of a home appliance. In other words, the coated steel sheet 100 of the present disclosure may be used as an exterior material of a home appliance. Types of home appliances to which the coated steel sheet 100 of the present disclosure is applied are not limited. Preferably, the coated steel sheet 100 of the present disclosure may be applied to home appliances to which a steel sheet material may be applied, such as a refrigerator and a washing machine.

Of course, the coated steel sheet 100 applied to home appliances or the like may further include a finishing coating layer on the outermost portion thereof as necessary. Of course, the coated steel sheet 100 of the present disclosure may be applied to any example of a device to which a steel sheet material may be applied as an exterior material, other than home appliances.

Further, the coated steel sheet 100 of the present disclosure that is applied to home appliances may be manufactured using a manufacturing method described below. Hereinafter, a method of manufacturing a coated steel sheet according to an embodiment of the present disclosure will be described with reference to the accompanying drawings.

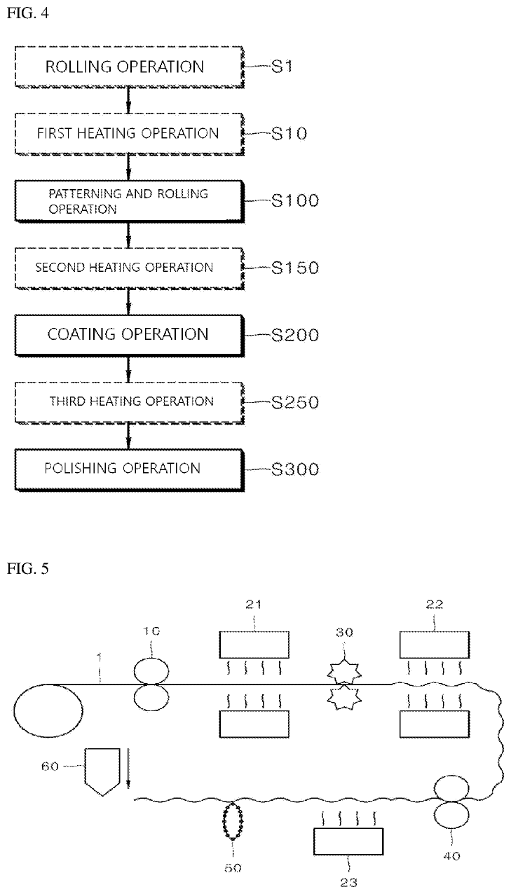

FIG. 4 is a process flowchart showing a method of manufacturing a coated steel sheet according to an embodiment of the present disclosure. Further, FIG. 5 is a process diagram schematically depicting the process of manufacturing the coated steel sheet according to an embodiment of the present disclosure.

As illustrated in FIG. 4, the method of manufacturing the coated steel sheet according to an embodiment of the present disclosure includes a patterning and rolling operation (S100), a coating operation (S200), and a polishing operation (S300).

Patterning and Rolling Operation (S100)

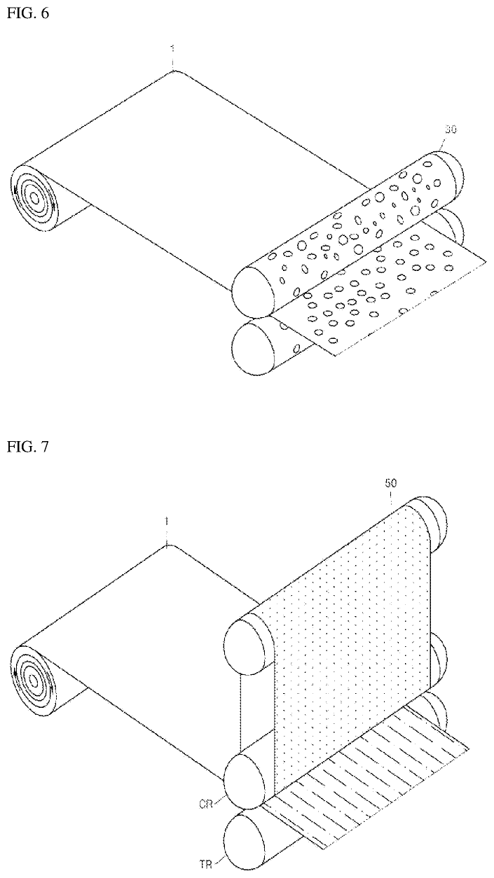

First, in the patterning and rolling operation (S100), a concave portion and a convex portion are formed on one surface of a steel sheet material. Referring to FIGS. 5 and 6, in the patterning and rolling operation (S100) of the present disclosure, a roller 30 having embossing formed thereon may be used to form the concave portion and the convex portion on the one surface of the steel sheet material.

Referring to FIGS. 5 and 6, prior to the patterning and rolling operation (S100), the manufacturing method of the present disclosure may, as necessary, include a rolling operation (51) of reducing a thickness of the steel sheet material and a first heating operation (S10) of heating the rolled steel sheet material.

In the rolling operation (51), a roller 10 may be used to roll the steel sheet material 1. Further, in the first heating operation (S10), a heating unit 21 having a hot air spraying nozzle may be used. The present disclosure is not limited thereto, and the first heating operation (S10) may be performed at temperatures in a range of 900° C. to 1,200° C.

Coating Operation (S200)

Next, in the coating operation (S200), the surface of the steel sheet material is coated with a coating material. Referring to FIG. 5, in the coating operation (S200), means such as a coating roll 40 may be used to coat the surface of the steel sheet material 1 with the coating material.

As described above, a known coating material may be used as the coating material. For example, acrylic or epoxy paint including a coloring agent may be used as the coating material. Further, a thickness of the coating layer 2 with which the surface of the steel sheet material 1 is coated may be properly controlled corresponding to the sizes of the concave portion and the convex portion formed on the surface of the steel sheet material 1.

Referring to FIGS. 5 and 6, prior to and after the coating operation (S200), the manufacturing method of the present disclosure may include a second heating operation (S150) and a third heating operation (S250) in which the coated steel sheet material is heated as necessary.

In the second heating operation (S150) and the third heating operation (S250), heating units 22 and 23 each having a hot air spraying nozzle may be used. The present disclosure is not limited thereto, and the second heating operation (S150) and the third heating operation (S250) may be performed at temperatures in a range of 900° C. to 1,200° C.

Polishing Operation (S300)

Next, in the polishing operation (S300), the coating layer is polished so that at least a portion of the convex portion formed on the surface of the steel sheet material is exposed to the outside and the coating material, which is colored, remains in the concave portion.

Preferably, in the polishing operation, a first polishing belt, a second polishing belt, and a third polishing belt may be sequentially used to polish the coating material. Here, surface roughness R1 of the first polishing belt, surface roughness R2 of the second polishing belt, and surface roughness R3 of the third polishing belt may satisfy Equation 1 below.

R1>R2>R3 [Equation 1]

The strongest polishing material is used for the first polishing belt to separate a coating layer protruding from the surface of the steel sheet material. A polishing material weaker than the polishing material of the first polishing belt is used for the second polishing belt to separate portions of the coating layer protruding from the surface of the steel sheet material not removed after the polishing using the first polishing belt and to secure flatness of the coating layer. Next, the weakest polishing material is used for the third polishing belt to improve the surface glossiness of the surface of the steel sheet material.

As above, a total of three polishing belts are used to polish the surface of the steel sheet material, and accordingly, the surface of the steel sheet may have a natural three-dimensional effect, color difference, and esthetic sense. A rotation speed (RPM) of the first polishing belt and the second polishing belt may be controlled to be in a range of 1,500 to 2,000, and a rotation speed (RPM) of the third polishing belt may be controlled to be in a range of 500 to 1,500.

Referring to FIG. 7, a rotation speed of polishing belts 50 may be controlled by a control roll CR. As described above, since the first polishing belt and the second polishing belt are used for the purpose of separating the coating layer of the steel sheet material, strong polishing materials may be used therefor, and the rotation speed of the first polishing belt and the second polishing belt may be controlled to be relatively high.

A polishing material having a particle size in a range of 100 mesh to 150 mesh may be used for the first polishing belt and the second polishing belt, and a polishing material having a particle size of 200 mesh or larger may be used for the third polishing belt. As described above, since the first polishing belt and the second polishing belt are used for the purpose of separating the coating layer of the steel sheet material, a relatively rough polishing material with sparsely distributed particles may be used therefor.

More specifically, for the first polishing belt, a belt made of a fabric material may be used, and a silicon carbide material (#120) may be used as polishing sand. Further, for the second polishing belt, a belt made of a fabric material may be used, and a silicon carbide material (Used #120) may be used as polishing sand. Next, for the third polishing belt, a Scotch-brite belt may be used, and a fine aluminum oxide material may be used as polishing sand.

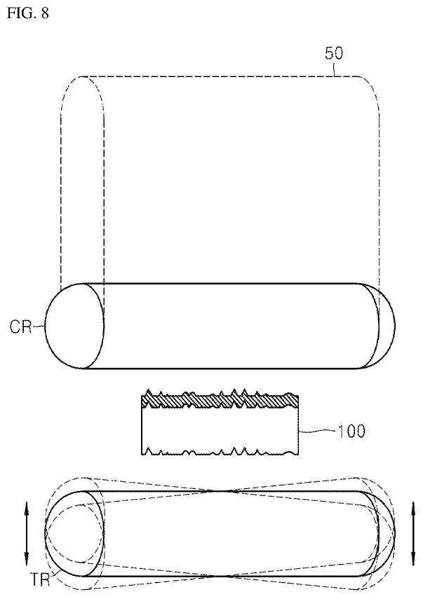

Referring to FIG. 8, in the polishing operation (S300) of the present disclosure, a roll TR with a tilted central axis may be placed below the coated steel sheet 100 including the steel sheet material, and the coating layer may be polished so that a removal rate of the coating layer is different in some parts thereof. By controlling the tilting angle and position of the roll TR, the surface of the coated steel sheet 100 may be polished as in the embodiment illustrated in FIG. 2 or 3, and accordingly, the surface of the coated steel sheet 100 may have various gradation effects. After being polished, the coated steel sheet 100 may be cut into appropriate sizes using equipment such as a blade 60.

The coated steel sheet 100 manufactured using the above-described method may be applied to an outer portion of a home appliance of the present disclosure, such as at least one of a body of the home appliance or a door to open and close a storage space defined by the body. More specifically, the coated steel sheet 100 may be manufactured in a large size and then cut to fit an object to which the coated steel sheet 100 will be applied. Here, the cut coated steel sheet 100 may be processed so that any one of left and right sides or any one of upper and lower sides thereof is bent to allow the cut coated steel sheet 100 to be coupled to an exterior of a home appliance.

In particular, the coated steel sheet 100 of the present disclosure may be coupled to an outer portion of a home appliance by a method using a hook or may be fixed thereto by various methods such as a coupling method using coupling between a bolt and a nut or a method using a screw.

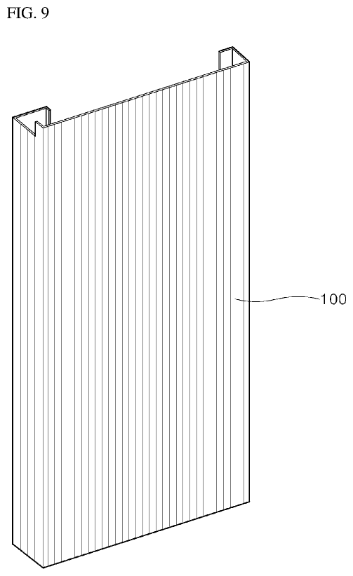

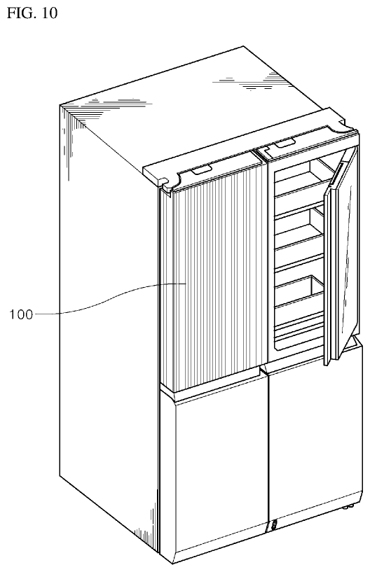

Referring to FIG. 9, it can be seen that the coated steel sheet 100 of the present disclosure has a structure in which both left and right sides thereof are bent to allow the coated steel sheet 100 to be applied to a home appliance. Further, referring to FIG. 10, a home appliance (e.g., a refrigerator) having an outer portion to which the coated steel sheet 100 processed as FIG. 9 is applied is illustrated. For reference, although the coated steel sheet 100 of the present disclosure is only applied to one of a plurality of doors in FIG. 10, the coated steel sheet 100 may be applied to all the doors as necessary.

As described above, the home appliance to which the coated steel sheet 100 of the present disclosure is applied is not limited to the refrigerator, and the coated steel sheet 100 of the present disclosure may be processed in various other shapes and applied to outer portions of home appliances other than the refrigerator. According to the present disclosure, since a surface of a coating layer is polished, at least a portion of a convex portion is exposed to an outside, and a concave portion is filled with a coating material. Therefore, a rich three-dimensional effect, various patterns, and a natural esthetic sense can be implemented.

Further, according to the present disclosure, since a removal rate is different in some parts in the coating layer of the coated steel sheet, a natural gradation pattern effect can be implemented. Also, according to the present disclosure, it is possible to provide a home appliance using a coated steel sheet which is manufactured using an economically feasible, simple method and capable of implementing a rich three-dimensional effect, various patterns, and a natural esthetic sense.

The present disclosure is directed to providing a coated steel sheet having a novel structure capable of implementing a rich three-dimensional effect, various patterns, and a natural esthetic sense that cannot be implemented using the conventional embossing method. The present disclosure is also directed to providing a coated steel sheet having a novel structure capable of implementing a natural gradation pattern effect. The present disclosure is also directed to providing a home appliance using a coated steel sheet manufactured to have a novel structure capable of implementing a rich three-dimensional effect, various patterns, and a natural esthetic sense.

Objectives of the present disclosure are not limited to the above-mentioned objectives, and other unmentioned objectives and advantages of the present disclosure should be understood from the following description and more clearly understood from embodiments of the present disclosure. Also, those of ordinary skill in the art should easily understand that the objectives and advantages of the present disclosure may be realized by the means shown in the claims and their combinations.

In a coated steel sheet according to the present disclosure, in particular, since a coating layer is polished, at least a portion of a convex portion of a surface of the steel sheet is exposed to an outside, and a concave portion is filled with a coating material, and thus it is possible to implement a rich three-dimensional effect, various patterns, and a natural esthetic sense.

More specifically, the coated steel sheet according to the present disclosure includes a steel sheet material which has a concave portion and a convex portion formed on one surface and a coating layer which is formed on the one surface by being coated on a coating material, wherein, as the coating layer is polished, at least a portion of the convex portion is exposed to an outside, and the concave portion is filled with the coating material.

Further, the coating layer of the coated steel sheet of the present disclosure may have a nonuniform thickness due to a removal rate being different in some parts. In particular, in the coating layer formed on the coated steel sheet of the present disclosure, a thickness at one side may be the thickest, and a thickness at the other side opposite to the one side in a longitudinal direction may be the thinnest. Also, in the coating layer formed on the coated steel sheet of the present disclosure, a thickness at a central portion may be the thickest. Accordingly, the coated steel sheet of the present disclosure may implement a natural gradation pattern effect.

Next, the coated steel sheet manufactured through a polishing operation in which the coating layer is polished so that at least a portion of the convex portion is exposed to the outside and the coating material, which is colored, remains in the concave portion is applied to an outer portion of a home appliance of the present disclosure. Other specific advantageous effects of the present disclosure in addition to the above-mentioned advantageous effects have been described above in describing details for practicing the disclosure.

The present disclosure has been described above with reference to the accompanying drawings, but the present disclosure is not limited by the embodiments disclosed herein and the drawings, and it is apparent that various modifications may be made by those of ordinary skill in the art within the scope of the technical idea of the present disclosure. Further, even when the effects according to configurations of the present disclosure are not explicitly described while describing the embodiments of the present disclosure, predictable effects of the corresponding configurations should also be recognized.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A coated metal sheet comprising:
a metal sheet including a surface having a concave region and a convex region; and
a coating layer which is provided on the metal sheet and includes a coating material,
wherein at least a portion of the convex region is exposed through the coating layer, and the concave region is filled with the coating material.

2. The coated metal sheet of claim 1, wherein the coating material is colored, and an upper surface of the convex region that is exposed through the coating layer and the coating material provided in the concave region are collinear.

3. The coated metal sheet of claim 1, wherein the coating layer has a thickness that is nonuniform due to a removal rate of the coating material during polishing of the coating layer being different in different regions of the coating layer.

4. The coated metal sheet of claim 3, wherein the thickness of the coating layer is greatest at a first end of the coated metal sheet and smallest at a second end of the coated metal sheet, the second end being opposite to the first end in a longitudinal direction.

5. The coated metal sheet of claim 3, wherein the thickness of the coating layer is greatest at a central region of the coated metal sheet.

6. The coated metal sheet of claim 1, wherein the metal sheet includes steel.

7. A home appliance comprising:
at least one of a body or a door; and
a coated metal sheet that is applied to an outer surface of the at least one of body or door,
wherein the coated metal sheet includes:
a metal sheet which has a concave region and a convex region formed on a surface; and
a coating layer which is provided on metal sheet, and
wherein at least a portion of the convex region is exposed through the coating layer, and the concave region is filled with the coating material.

8. The home appliance of claim 7, wherein the metal sheet includes steel.

9. The home appliance of claim 7, wherein:
the concave region and the convex region are formed on the surface of the metal sheet in a patterning and rolling operation,
the coating material is colored and is coated on the surface of the metal sheet in a coating operation in which the coating material is applied over upper surfaces of the concave region and the convex region, and
the coating material is polished in a polishing operation after the coating operation so that at least a portion of the convex region is exposed, and the coating material is provided in the concave region.

10. The home appliance of claim 9, wherein:
prior to the patterning and rolling operation, the metal sheet is heated in a first heating operation, and
after the patterning and rolling operation, the metal sheet is heated in a second heating operation.

11. The home appliance of claim 10, wherein the first heating operation and the second heating operation are performed at temperatures in a range of 900° C. to 1,200° C.

12. The home appliance of claim 9, wherein between the coating operation and the polishing operation, the metal sheet is heated in a third heating operation.

13. The home appliance of claim 12, wherein the third heating operation is performed at temperatures in a range of 900° C. to 1,200° C.

14. The home appliance of claim 9, wherein, in the polishing operation:
a first polishing belt, a second polishing belt, and a third polishing belt are sequentially used to polish the coating material; and
a surface roughness (R1) of the first polishing belt is greater than a surface roughness (R2) of the second polishing belt, and a surface roughness (R3) of the third polishing belt is less than the surface roughness (R1) of the first polishing belt and the surface roughness (R2) of the second polishing belt.

15. The home appliance of claim 14, wherein:
a rotation speed (RPM) of the first polishing belt and the second polishing belt is in a range of 1,500 to 2,000; and
a rotation speed (RPM) of the third polishing belt is in a range of 500 to 1,500.

16. The home appliance of claim 14, wherein:
the first polishing belt and the second polishing belt include a polishing material having a particle size in a range of 100 mesh to 150 mesh, and
the third polishing belt includes a polishing material having a particle size of 200 mesh or larger is used for the third polishing belt.

17. The home appliance of claim 9, wherein, in the polishing operation, a roller with a tilted central axis is placed below the metal sheet to polish the coating material so that a removal rate of the coating material varies in different regions of the coated metal sheet.

18. The home appliance of claim 7, wherein the door opens and closes a storage space defined by the body.

19. The home appliance of claim 7, wherein the exposed portion of the convex region and the concave region are collinear.

20. A coated metal sheet comprising:
a metal sheet including a surface having a first region, and second region that is recessed relative to the first region; and
a coating material that is provided on the surface of the metal sheet such that at least a portion of the first region is exposed through the coating material, and the coating material is provided in the second region.
